(19) United States
(12) Patent Application Publication
(10) Pub. No.: US 2017/0083679 A1
(43) Pub. Date: Mar. 23, 2017

(54) SYSTEMS AND METHODS FOR USING NON-MEDICAL DEVICES TO PREDICT A HEALTH RISK PROFILE

(71) Applicant: DELL PRODUCTS L.P., Round Rock, TX (US)

(72) Inventors: Seth Mercur Feder, Austin, TX (US); Carrie Elaine Gates, Livermore, CA (US); Gabriel Mauricio Silberman, Austin, TX (US)

(73) Assignee: DELL PRODUCTS L.P., Round Rock, TX (US)

(21) Appl. No.: 14/857,600

(22) Filed: Sep. 17, 2015

(51) Int. Cl. G06F 19/00

(52) U.S. Cl. CPC G06F 19/3431

(57) ABSTRACT

The present invention relates generally to a prediction of health risk. Aspects of the present invention include using a general model to model a user's health risk. In embodiments of the present invention the general model is modified to a user's specific behaviors or inputs. In embodiments of the present invention the model is compared to actual data obtained by sensors in everyday consumer products. In embodiments of the present invention, based on the outcome of the comparison, an emergency response can be triggered and or health and wellness improvement behaviors can be suggested.

### BACKGROUND

Field of Invention

The present invention relates generally to health risk profiles, and relates more particularly to using non-medical devices and inputs to predict a health risk profile.

Description of the Related Art

As the medical industry continues to grow, health care providers and consumers seek additional ways to evaluate and predict health risks. One option available today is for a patient to go to a medical doctor where expensive medical equipment is used to determine health risk. However, typically, a patient only seeks out medical care when the patient realizes that medical care is needed. In other words, only when there is already a clear medical problem, the patient will seek out a doctor. The doctor has a lot of expensive equipment, imaging techniques, laboratories, and tools at his disposal. The doctor also has a starting point for his health inquiry because that is why the patient sought him out in the first place.

However, what is needed is a way to predict health risks without the patient knowing he has a health problem and without using expensive medical equipment.

### BRIEF DESCRIPTION OF THE DRAWINGS

Reference will be made to embodiments of the invention, examples of which may be illustrated in the accompanying figures, in which like parts may be referred to by like or similar numerals. These figures are intended to be illustrative, not limiting. Although the invention is generally described in the context of these embodiments, it should be understood that it is not intended to limit the spirit and scope of the invention to these particular embodiments. These drawings shall in no way limit any changes in form and detail that may be made to the invention by one skilled in the art without departing from the spirit and scope of the invention.

FIG. 1 depicts a block diagram of a health risk prediction system according to embodiments of the present invention.

FIG. 2 depicts a block diagram of a health risk prediction system according to embodiments of the present invention.

FIG. 3 depicts a block diagram of a personal predictive medical analytics system according to embodiments of the present invention.

FIG. 4 depicts a flow chart to determine context according to embodiments of the present invention.

FIG. 5 depicts a flow chart to collect sensor inputs according to embodiments of the present invention.

FIG. 6 depicts a flow chart of resulting actions according to embodiments of the present invention.

FIG. 7 depicts a flow chart to modify a generic model according to embodiments of the present invention.

### DESCRIPTION OF THE PREFERRED EMBODIMENTS

In the following description, for purposes of explanation, specific examples and details are set forth in order to provide an understanding of the invention. It will be apparent, however, to one skilled in the art that the invention may be practiced without these details. Well known process steps may not be described in detail in order to avoid unnecessarily obscuring the present invention. Other applications are possible, such that the following examples should not be taken as limiting. Furthermore, one skilled in the art will recognize that aspects of the present invention, described herein, may be implemented in a variety of ways, including software, hardware, firmware, or combinations thereof.

Components, or modules, shown in block diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components or modules.

Furthermore, connections between components within the figures are not intended to be limited to direct connections. Rather, data between these components may be modified, re-formatted, or otherwise changed by intermediary components (which may or may not be shown in the figure). Also, additional or fewer connections may be used. It shall also be noted that the terms “coupled” or “communicatively coupled” shall be understood to include direct connections, indirect connections through one or more intermediary devices, and wireless connections.

In the detailed description provided herein, references are made to the accompanying figures, which form a part of the description and in which are shown, by way of illustration, specific embodiments of the present invention. Although these embodiments are described in sufficient detail to enable one skilled in the art to practice the invention, it shall be understood that these examples are not limiting, such that other embodiments may be used, and changes may be made without departing from the spirit and scope of the invention.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, such phrases in various places in the specification are not necessarily all referring to the same embodiment or embodiments. It shall be noted that the use of the terms “set” and “group” in this patent document shall include any number of elements. Furthermore, it shall be noted that methods or algorithms steps may not be limited to the specific order set forth herein; rather, one skilled in the art shall recognize, in some embodiments, that more or fewer steps may be performed, that certain steps may optionally be performed, and that steps may be performed in different orders, including being done some steps being done concurrently.

The present invention relates in various embodiments to devices, systems, methods, and instructions stored on one or more non-transitory computer-readable media involving the communication of data over networks. Such devices, systems, methods, and instructions stored on one or more non-transitory computer-readable media can result in, among other advantages, the ability to predict health risk profiles using everyday components.

It shall also be noted that although embodiments described herein may be within the context of prediction of health risk profiles, the invention elements of the current patent document are not so limited. Accordingly, the invention elements may be applied or adapted for use in other contexts.

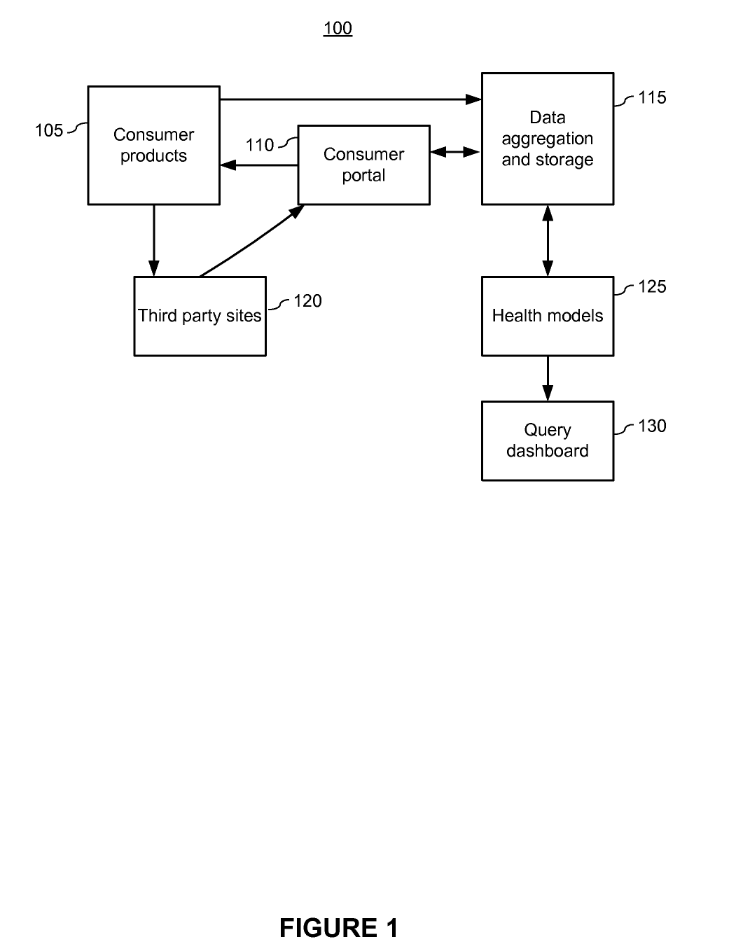

FIG. 1 depicts a block diagram of a health risk prediction system according to embodiments of the present invention. FIG. 1 shows health risk prediction system 100. Health risk prediction system includes consumer products 105, consumer portal 110, data aggregation and storage 115, third party sites 120, health models 125, and query dashboard 130.

Consumer products 105 can be any consumer products that can collect information about a user. Examples of consumer products include, smart phones, computers, cameras, cars, handheld electronic devices, tablets, watches, exercise equipment, furniture, appliances, and other device that has the ability to sense information about a user. For example, a computer or cell phone can collect information related to the posture, keystrokes, swipe strokes, look, gaze, position, and other information related to a user. Other consumer products can also collect information about a user, for example, cameras, cars, watches, exercise equipment, furniture, computer systems, etc. These devices can collect information about a user's heart rate, calorie consumption, orientation, location, speed, exertion level, gaze, hand strength, posture, etc. Information can be continuously collected from these consumer products 105.

The collected information can be stored in data aggregation and storage 115. Also, information can be entered by a user in a consumer portal 110. In some embodiments a consumer portal can be a set of questions about a user's health and habits. For example, a user can input his exercise schedule, travel schedule, food journal, overall health, health problems, age, weight, height, gender, known health specific problems, etc.

Some consumer products can also send information to a third party site 120. Some exercise equipment, for example, has its own site that can store the information about a user's exercise habits, calories burned, steps walked, heart rate, etc. Alternatively, a third party site 120 can be used for collecting videos made by a user or a user's calendar or location information determined from a global positioning system (GPS) in a consumer device. The information in the third party site 120 can also be sent to the consumer portal 110. The user can allow automatic download of this information. Alternatively, the user can enter it on a per transaction basis. The information about the user from the consumer portal 110 can also be sent to the data aggregation and storage 115.

The data stored in the data aggregation and storage 115 can be used with health models 125. The health models 125 can be derived from both advanced analytics and decision optimization technologies. Advanced analytics such as statistics, data mining, and text mining can evaluate the available data inputs with bias towards those known to contribute to certain conditions. The model can consider data inputs available for a particular user. For example, if a person has a smart phone only, then the health models 125 need only consider information it can obtain from this particular device. For example, in the smart phone only embodiment, accelerometer information can be used to determine gait information and jitter in hand movements when using the device, the camera can be used to obtain information about the user's face, in some embodiments, a heart sensor on the phone can be used to obtain heart rate information.

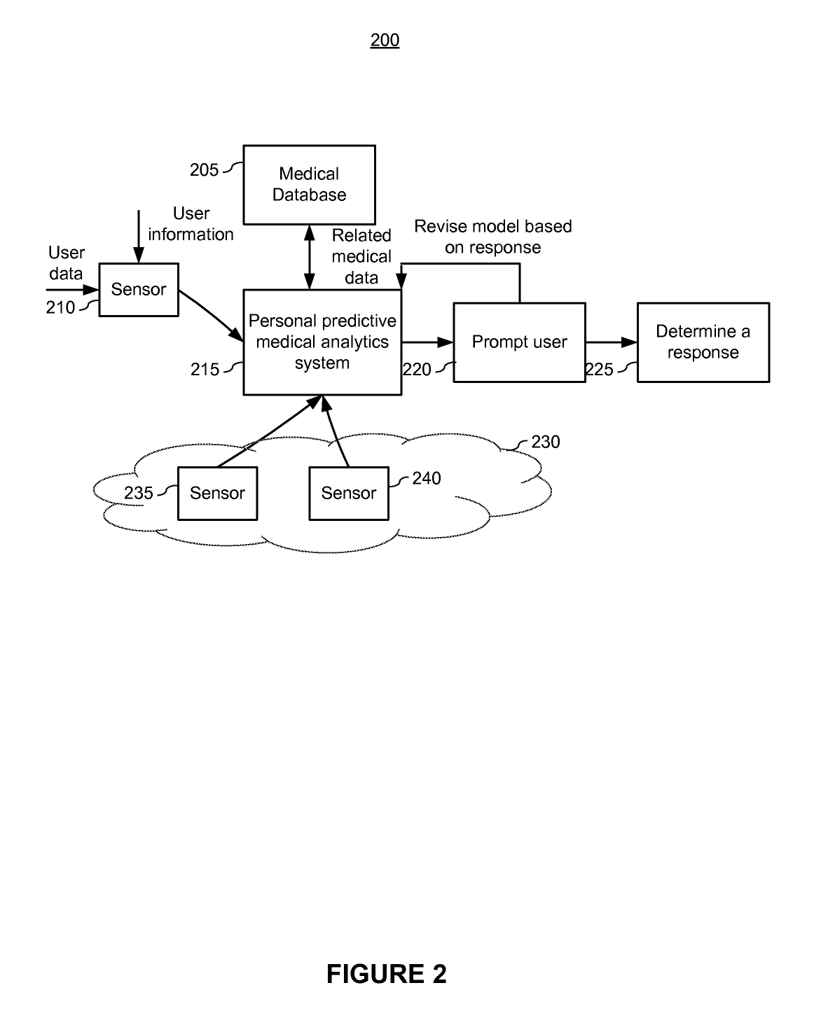

The health models 125 can output to a query dashboard 130 to ask the user if there is a problem or to otherwise assist the system in refining its understanding of the current health status of the user. In some embodiments, the query dashboard 130 can be used to query or inform the user about potential solutions to the user's predicted problem, the health model, or a medical database in order to improve overall health and wellness. FIG. 2 depicts a block diagram of a health risk prediction system according to embodiments of the present invention. FIG. 2 shows health risk prediction system 200. The health prediction system 200 can identify pathologies or other risks to a user's wellbeing (accidents, lack of exercise). The health prediction system 200 makes use of a personal predictive medical analytics system 215. An input to the personal predictive medical analytics system 215 is a symptom of a potential problem captured serendipitously from available sensors 230 and analyzed by the personal predictive medical analytics system 215. When a reading falls outside its normal range, the system 200 can make an attempt to ascertain whether it is a true symptom or caused by other, non-pathological factors. This attempt can be made by the system 200 by gathering readings from as many complementary sources (mobile devices, fixed cameras, ambient sensors) as they are available 210. These sources include other personal (GPS in a phone, health record, previously recorded data) or environmental (weather, pollution or other information available from online services or news/RSS feeds) inputs. The system 200 can also prompt the user 220. If none of the available readings can explain away the symptom, then all the information thus gathered (initial reading and complementary information) can feed into a diagnosis phase to determine a response 225.

This diagnosis phase can use a decision-tree based method or other advanced algorithmic approaches such as k-Nearest Neighbor, Recursive Partitioning, Neural Networks, Self-organizing feature maps, or Model ensembles (combining two or more models together). The system can also employ a machine learning engine to identify and correlate new data inputs with health conditions, in its goal of performing root-cause analysis for the problem(s) responsible for the symptom(s).

Health risk prediction system 200 includes sensor 210. Sensor 210 can take user data or user information and feed it into personal predictive medical analytics system 215. Also, in some embodiments, medical database 205 can be used to obtain medical related data. For example, if a particular user has a known health condition, such as a heart problem or an injured knee that information can be determined from the medical database 205.

Further cloud 230 includes an internet of things. An internet of things refers to everyday devices or consumer devices 105 shown as sensors 235 and 240, such as phones, cars, office equipment, computers, exercise equipment, tablets, televisions, cameras, etc. that can sense information about a user. That information is also fed into the personal predictive medical analytics system 215.

The personal predictive medical analytics system 215 takes that information and predicts a possible health issue. Personal predictive medical analytics system 215 starts with a known health model based on the general population and then constructs an individualized model one over time. It does this using advanced analytics such as for example, k-Nearest Neighbor, Recursive Partitioning, Neural Networks, Self-organizing feature maps, or Model ensembles (combining two or more models together). Based on the results of the personal predictive medical analytics system 215, if an issue is predicted, the user can be prompted with a question 220.

Decision optimization uses techniques such as scoring and rules engines to inform the personal predictive medical analytics system 215. The personal predictive medical analytics system can be seeded with general rules and recommendations derived from the general population in order to begin narrowing down all the possibilities. These rules reflect clinical best practices for identifying pathologies, as well as represent other scenarios, such as accidents or environmental threats with potential impact on a person's wellbeing. Furthermore, as the system collects data about a user, it can utilize the personal predictive medical analytics system 215 to update these optimizations and recommendations to best suit the user. Data collected may include sensor data, information acquired from digital sources (e.g., medical records), or through explicit user input.

If no general rule exists for a set of values the model considers outside the norm, the personal predictive medical analytics system 215 can create a new rule based on feedback from the user.

For example, the personal predictive medical analytics system 215 notices a user has decreased exercise load suddenly, and prompts the user for some explanation (illness, bored, injured, too busy, etc.). Then in the future when these patterns repeat, a prediction can be derived in advance.

Further refinement of the model may be possible using the outcome of the diagnosis phase above, in terms of what (available) sensors should be monitored and with what frequency, and any shortcuts (e.g., irrelevant sensors) available to arrive at a diagnostic faster. This kind of refinement may be applicable in the context of a specific user, the broader demographic the user represents, or the general population.

For example, a sensor, possibly a cell phone, senses an increase in a user's heart rate. The system 200 can refer to other sources of information to determine if the user is at the gym or has scheduled a run with a friend. The system 200 can obtain that information from the internet of things 230, e.g., from a GPS signal from the user's cell phone or from the user's calendar entries, or from user input from sensor 210. If the system 200 determines that the user is at the gym, then the user is likely exercising and the sudden increase in heart rate has an explanation other than a health issue for the user. If the secondary sources do not rule out a medical issue, then the user can be prompted with a question about whether or not the user is exercising. If the user responds that the user is exercising, then the system 200 has an explanation other than a health issue for the increase in heart rate. If the user does not respond or responds that the user is not exercising, then the system 200 enters the diagnosis phase to determine a response 225. In determining a response, the diagnosis phase can use a decision-tree based method or other algorithmic approaches, including machine learning, for performing root-cause analysis looking for the problem(s) responsible for the symptom(s). The root-cause will drive the system 200 response.

Another example is if a sensor senses that a user has gained body weight over a period of time. The system 200 can refer to other sources of information to determine if the user has been regularly exercising and what foods the user has been eating. The system 200 can obtain that information from the internet of things 230, e.g., from a GPS signal from the user's cell phone or from the user's calendar entries, or from user input from sensor 210. If the system 200 determines that the user has been performing resistance training at the gym, and has caloric intake in line with recommended limits, then there is a possible explanation for the change in weight. If the secondary sources do not rule out unhealthy weight gain, then the user can be prompted with a question about whether or not the recent changes in weight are due to muscle or fat gain. If the user responds that weight gain is muscle mass, then the system 200 has an explanation other than a health issue for the sudden change in weight.

If the user respond that the user has gained fat, then the system 200 enters the diagnosis phase to determine a response 225. In determining a response, the diagnosis phase can use a decision-tree based method or other algorithmic approaches, including machine learning, for performing root-cause analysis looking for the problem(s) responsible for the symptom(s). The root-cause will drive the system 200 response. The response can be a suggested alteration in diet strategy or a suggested change in exercise regimen.

Once the user has been prompted, a response can be determined 225. For example, if the user was sensed as suddenly going from moving 55 mph to being stationary, and did not respond to a prompt and the user is in his car, then one response is to activate EMS. In some examples, a response can be to call the user's physician. In other examples, a response can be to send someone to check on the user.

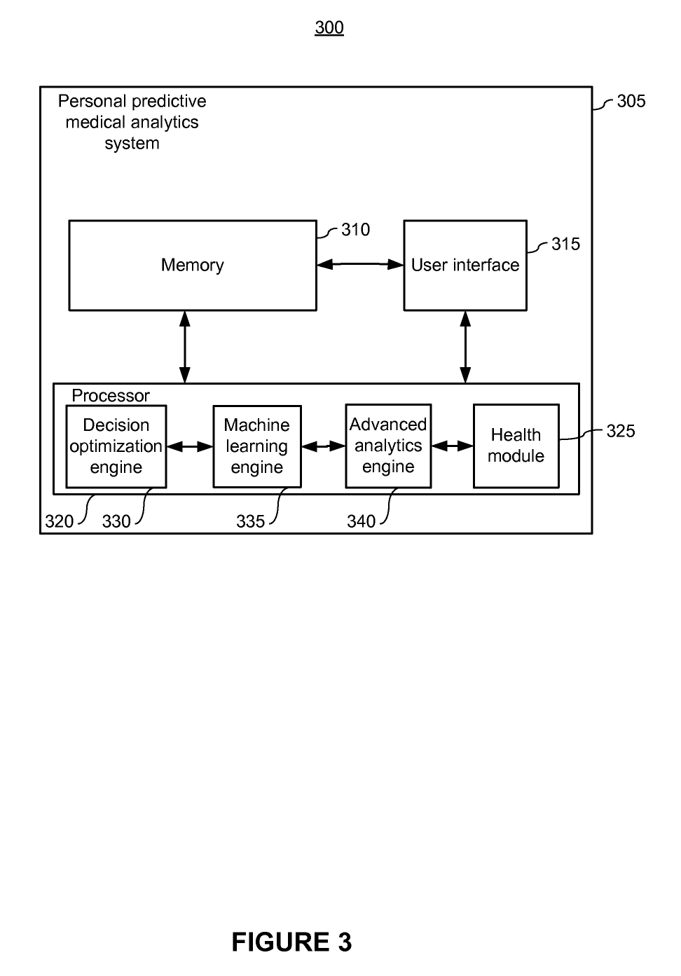

FIG. 3 depicts a block diagram of a personal predictive medical analytics system according to embodiments of the present invention. FIG. 3 shows a personal predictive medical system 300 including memory 310. Memory 310 can be any kind of data storage, for example, random access memory (RAM), read only memory (ROM), hard disk drive space, cloud storage space, or any other kind of memory used to store data. Memory 310 can be used to store the information gathered by the various sensors. It can also be used to store information input by a user or from a medical database. Further, it can store information collected over time and determined differences between the current information and past information.

For example, information about many different keystrokes or swipe strokes can be stored. That information can lead the system to determine that there is a difference between current and past user performance. That difference can indicate a plurality of potential health risks.

Personal predictive medical system 300 also includes processor 320. Processor 320 can be any kind of processor used to perform these types of functions, for example, processors found in servers, including cloud environments or virtual machine servers, or personal computing environments. Processor 320 can execute a health model 325. Processor 320 can also execute an advanced analytics engine 340. Advanced analytics engine 340 can use techniques such as statistics, data mining, and text mining to evaluate the available data inputs with bias towards those known to contribute to certain conditions. The model can consider data inputs available for a particular user. Decision optimization engine 335 can also be executed on processor 320. Decision optimization engine 335 uses techniques such as scoring and rules to inform the personal predictive medical analytics system 305. The personal predictive medical analytics system 305 can be seeded with general rules and recommendations derived from the general population in order to begin narrowing down all the possibilities. These rules reflect clinical best practices for identifying pathologies, as well as represent other scenarios, such as accidents or environmental threats with potential impact on a person's wellbeing. Furthermore, as the system collects data about a user, it can utilize the personal predictive medical analytics system 305 to update these optimizations and recommendations to best suit the user. Data collected may include sensor data, information acquired from digital sources (e.g., medical records), or through explicit user input.

Processor 320 can also execute a machine learning engine 330 to identify and correlate new data inputs with health conditions, in its goal of performing root-cause analysis for the problem(s) responsible for the symptom(s).

Memory 310 and processor 320 both interface with user interface 315. User interface 315 can include an interface for the user to input personal or health information. User interface 315 can also be the interface to prompt the user should a problem be suspected.

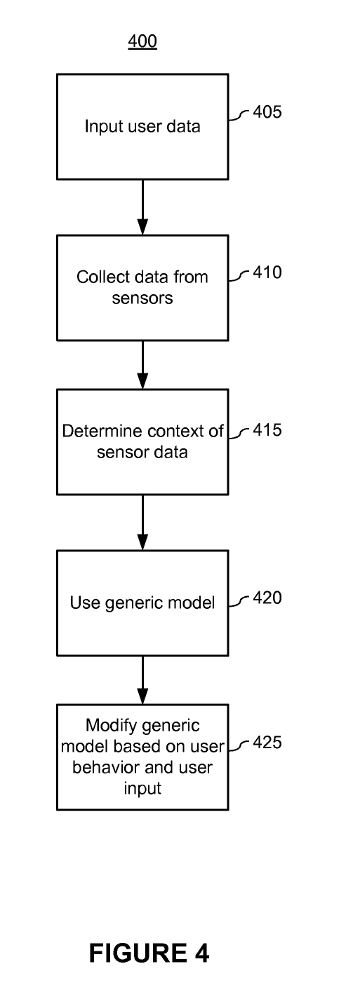

FIG. 4 depicts a flow chart to determine context according to embodiments of the present invention. FIG. 4 shows process 400 including inputting user data 405. This inputting can be achieved using a user interface and some questions prompting the user for information. It can also be achieved from reviewing user information on third party platforms or medical records.

Process 400 also includes collecting data from sensors 410. As described above sensors in everyday objects and consumer products can be used to predict health risks. Process 400 also includes determining the context of the sensor data 415. Determining the context of the sensor data is particularly important since the system and process do not know there is a problem or what it is as distinguished from the prior art case where the user would seek out medical care. The health prediction system may not be able to predict many types of medical, health or environmental problem without knowing the context. For example, consider the prediction of a fall, a car accident, a heart attack, or a stroke. The sensor data and context is very different in each of those examples. Further, the sensor data can be read when a person is asleep, at work, exercising, walking, reading, sitting, standing, running, and many other contexts.

Sensor readings vary greatly depending on the context in which the person being monitored exists, and must be known in order to make effective use of the data. Elements that define context can include: posture, circumstance, activity, and location. Posture can include determination of whether the user is sitting, standing still, walking, lying down, etc. Circumstance can include determination of whether the user is stationary or on a conveyance such as a car, bus elevator, plane, etc. Activity can include determination of whether a user is engaged in strenuous physical activity such as biking, jogging, hiking, etc. Location can include a determination of where the user is for example, at home, at work, at a public event, in an accident, etc.

The process 400 determines context by beginning with a generic profile for the “norm” of the user based on his age, gender, height, ethnicity, geographic location, etc. 420. For an initial training period the system and process 400 tracks this norm, and secondarily deviations from that norm can then be computed beyond a given threshold (e.g., standard deviation). The user can be queried about possible factors to explain the difference in order to train the system. For example, an uneven gait may prompt questions about an existing leg or hip condition. The model can be modified based on user behavior or user response 425. Responses justifying a variance from the generic norm can be incorporated into the personal model. Otherwise, the person can be referred to a health-care provider or coach to check on the detected deviation from the norm.

A generic model can be obtained by accessing relevant population health repositories and applying statistical techniques and analytical modeling. The personal model can be continuously updated, e.g., using Machine Learning, as the user interacts with different environments, as well as periodically to take into account seasonal changes for the geography, advances in age, and other underlying progressive conditions, natural or pathological, the personal model may have detected.

Posture for example may be determined by a variety of sensor inputs, including high accuracy GPS, the accelerometers of a smartphone, tablet, or cameras. Full context may also be gleamed from the same sensors, in addition to identifying nearby WiFi or other networks, beacons or other radiating stations. Location is readily available from a subset or combination of the above sensors.

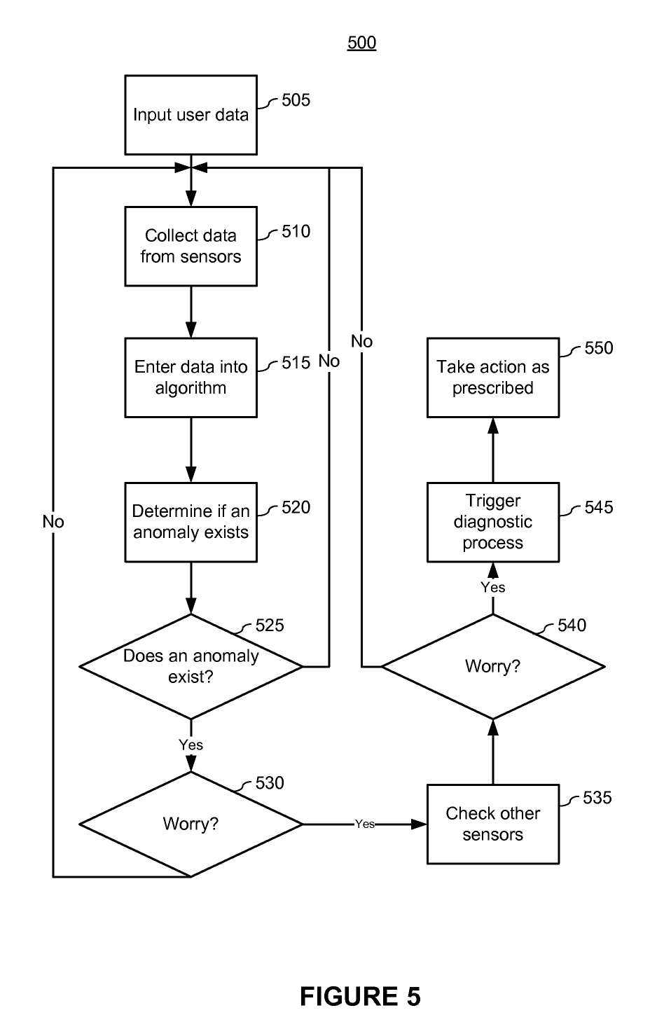

FIG. 5 depicts a flow chart to collect sensor inputs according to embodiments of the present invention. FIG. 5 shows process 500 including inputting user data 505. Collecting data from sensors 510.

During ongoing operation the system can gather input from sensors, such as smartphone and laptop accelerometers (to detect jitter and gross motor control), touch screen gestures and mouse movements (repeated motions, overshooting, tremor), as well as cameras (skin color, perspiration, eye movement, eye coloring, pupil dilation). In addition to these devices, inputs may be gathered from wearable computing (smartwatch, exercise monitors) and house monitoring (cameras, motion detectors, thermostats) devices.

The above inputs are aggregated and compared against the personal model. Process 500 also shows entering the data into an algorithm 515. When deviations are detected, these can be passed on to the analysis portion of the system. The results of the analysis can feed back into the personal model to create additional options for normative behavior, or to track an ongoing condition.

Process 500 also determines if an anomaly exists 520 by comparing the data to the personal model for the user. Process 500 asks if an anomaly exists 525. If an anomaly does exist, the process 500 asks if worry is necessary 530. If an anomaly does not exist, then process 500 collects again data from sensors 510. If there is a cause for worry, then process 500 checks other sensors 535 and asks again about worry 540. If there is not a cause for worry, then process 500 collects again data from sensors 510. If there is reason to worry, then a diagnostic process is triggered 545 and action is taken as prescribed 550. If there is not a cause for worry, then process 500 collects again data from sensors 510.

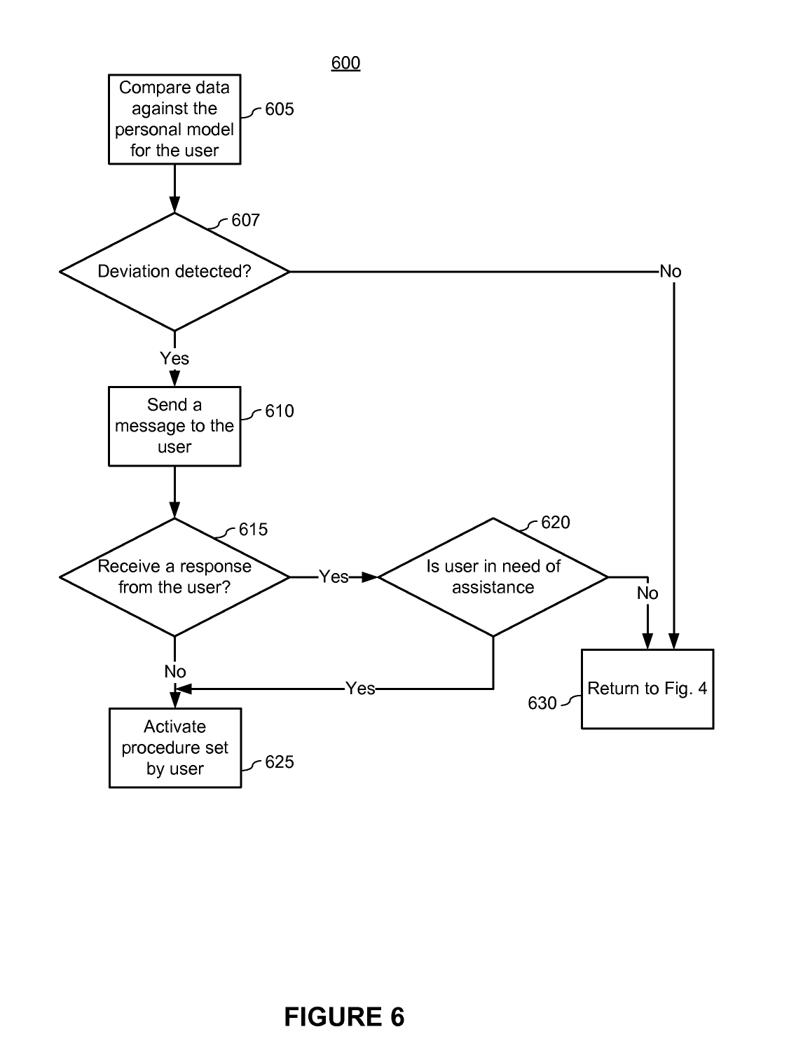

FIG. 6 depicts a flow chart of resulting actions according to embodiments of the present invention. FIG. 6 shows process 600 including comparing data against data in the personal model for the user 605.

The process 600 asks whether a deviation is detected 607. Whenever a deviation from the personal model is detected, which exceeds a given threshold, the system translates the anomaly in sensor readings to a possible set of pathological symptoms. This translation can be based on predictive analytics of medical diagnostic databases, such as WebMD, complemented by information derived from population health information repositories. The personal model can be used as a filter to distinguish the person from the generic population profile as determined by statistical modeling.

If the deviation maps to a pathology, the system asks the user a number of simple questions 610 about their current/recent activity (climbing stairs) and possibly for the occurrence of certain symptoms (shortness of breath). If a deviation is not detected, the process returns to FIG. 4 630. The process asks if a response was received by the user 615. If a response is not forthcoming, or the answers indicate a possible condition, the system may notify the user with textual or voice messages, and or a family member, friend or care provider (possibly including emergency services), via phone, text, email, etc. 625. All notifications can be controlled by authorizations and modalities the user has enabled in the system. If a response is received, but indicates the user needs assistance, then the system set by the user can be activated 625. If the user is not in need of assistance, then process 600 can return to FIG. 4 630.

Suggestions for specific actions, such as consulting a physician or calling an ambulance, are based on well-known triage practices as used by many healthcare providers to assist their patients remotely.

An additional option is to directly connect the user's device with a healthcare/emergency service, depending on the severity of the situation, to enable two-way communication and better assess the best course of action.

In addition to monitoring the early onset of pathologies, the system may also be used for wellness monitoring. For example, tracking the level of physical activity of a stroke victim, normative behavior of an elderly user (lying down at an unusual location or time), as well as other normative or target behaviors.

An example of embodiments of the present invention is a user is detected as sleeping by the microphone of a tablet resting on a bedside table detecting regular slow breathing. Suddenly the microphone detects accelerated breathing followed by no breathing at all. Embodiments of the present invention may interrogate the motion sensor in the room to check if the user left the bed. Other sensors in the room can also be checked, for example, the camera on the tablet can detect whether a light has been turned on. If neither sensor shows activity, embodiments of the present invention may infer the user is still lying in bed and may not be breathing. If that is the case, it can attempt to establish voice communication with the user. If unable to establish voice communication with the user, embodiments of the present invention can trigger an emergency procedure (alert people at home, emergency services, etc.). If the sensors show actions consistent with the person rising from bed and leaving the room, no action is taken.

Another example of embodiments of the present invention is that by monitoring GPS embodiments of the present invention has determined a smartphone is being carried in a car. The phone's accelerometer detects a sudden deceleration consistent with a very sudden stop, while at the same time its microphone captures screaming. Embodiments of the present invention interrogate the person in the car, but it turns out the driver stopped suddenly to avoid a child chasing a ball onto the road near a busy playground. If there was no response, embodiments of the present invention may have attempted reading other sensors, for example, the car's OnStar status, to ascertain whether the car's airbags had deployed. If the airbags had deployed, embodiments of the present invention would alert emergency services and others as per the user's preferences.

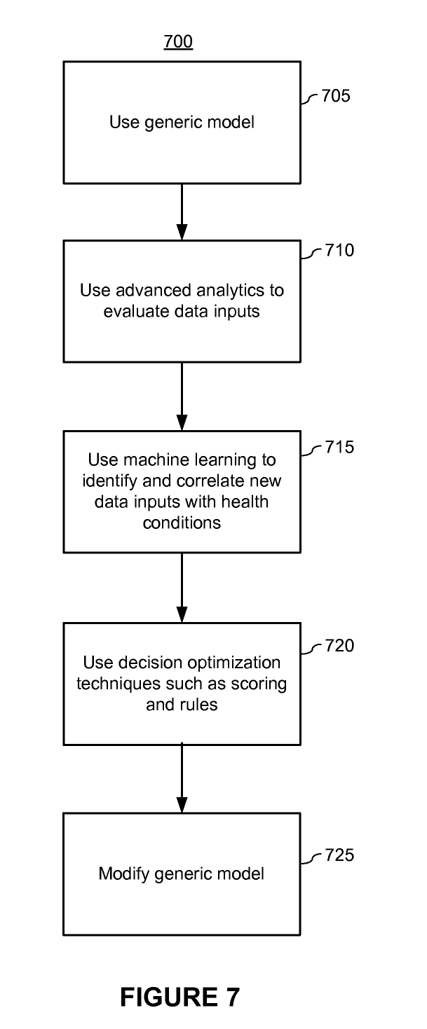

FIG. 7 depicts a flow chart to modify a generic model according to embodiments of the present invention. FIG. 7 shows process 700 including using a generic model 705. FIG. 7 also shows a modification of the generic model using advanced analytics to evaluate data inputs 710. Advanced analytics such as statistics, data mining, and text mining can evaluate the available data inputs with bias towards those known to contribute to certain conditions. The model can consider data inputs available for a particular user. Machine learning can be used to identify and correlate new data inputs with health conditions 715. The system can employ a machine learning engine to identify and correlate new data inputs with health conditions, in its goal of performing root-cause analysis for the problem(s) responsible for the symptom(s). Decision optimization techniques such as scoring and rules 720 can be used to inform the personal predictive medical analytics system. The generic model can be modified based on the above techniques 725.

One advantage of the present invention is that it provides a prediction of health risks.

Another advantage of the present invention is that a user can be helped if the user needs help.

Yet another advantage of the present invention is that the user can monitor his health without the need for expensive, dedicated medical equipment.

One of ordinary skill in the art will appreciate that various benefits are available as a result of the present invention.

It shall be noted that aspects of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

While the inventions have been described in conjunction with several specific embodiments, it is evident to those skilled in the art that many further alternatives, modifications, application, and variations will be apparent in light of the foregoing description. Thus, the inventions described herein are intended to embrace all such alternatives, modifications, applications and variations as may fall within the spirit and scope of the appended claims.

What is claimed is:

1. A health risk prediction system for predicting a health risk profile of a user, the system comprising:
a data storage that stores data collected from a consumer product sensor and data input into the data storage; and
a personal predictive medical analytics system that:
creates a general health model;
modifies the health model based on learned behavior;
compares the data stored in the data storage to the modified health model to determine a deviation in the data from the modified health model; and
generates a predictive health risk profile based on the comparison.

2. The system of claim 1 wherein the personal predictive medical analytics system triggers a diagnostic response.

3. The system of claim 1 wherein the personal predictive medical analytics system inquires further regarding the health risk profile.

4. The system of claim 1 wherein the personal predictive medical analytics system activates a response.

5. The system of claim 1 wherein the consumer product is a phone.

6. The system of claim 1 wherein the consumer product is a computer.

7. The system of claim 1 wherein the consumer product is a car.

8. A method for generating a predictive health risk profile, comprising:
collecting data from a consumer product sensor;
creating a general health model for a user;
modifying the general health model for the user based on the user's behavior to create a specific health model;
comparing the data to the specific health model to determine a deviation in the data from the specific health model; and
generating a predictive health risk profile based on the comparison.

9. The method of claim 8 further comprising triggering a diagnostic response.

10. The method of claim 8 further comprising inquiring further regarding the health risk profile.

11. The method of claim 8 further comprising activating a response.

12. The method of claim 8 wherein the consumer product is a phone.

13. The method of claim 8 wherein the consumer product is a computer.

14. The method of claim 8 wherein the consumer product is a car.

15. A context determination method in generating a health prediction profile, comprising:
collecting a first data from a first sensor in a first consumer product;
determining the context of the first data to determine information about a user relating to the user's environment;
using the context of the data to collect a second data from a second consumer product;
collecting the second data from the second consumer product;
correlating the first and second data based on the context;
comparing the first and second data to a health model; and
triggering a response based on the outcome of the comparison such that if the data deviates from the model, the response includes prompting the user.

16. The method of claim 15 wherein the first consumer product is a phone.

17. The method of claim 15 wherein the first consumer product is a tablet.

18. The method of claim 15 further comprising activating an emergency response based on a response from the user to the prompting.

19. The method of claim 15 wherein the health model is k-Nearest Neighbor.

20. The method of claim 15 wherein the health model is updated based on user behavior.
